(19) United States
(12) Patent Application Publication
(10) Pub. No.: US 2018/0295293 A1
(43) Pub. Date: Oct. 11, 2018

(54) METHOD AND APPARATUS FOR GENERATING A PANORAMIC IMAGE HAVING ONE OR MORE SPATIALLY ALTERED PORTIONS

(71) Applicant: NOKIA TECHNOLOGIES OY, Espoo (FI)

(72) Inventors: Yajie SUN, Palo Alto, CA (US); Jussi Artturi LEPPANEN, Tampere (FI)

(21) Appl. No.: 15/484,671

(22) Filed: Apr. 11, 2017

(51) Int. Cl. H04N 5/265; H04N 5/232; G06T 3/60

(52) U.S. Cl. CPC H04N 5/265; G06T 3/60; H04N 5/23238

(57) ABSTRACT

A method, apparatus and computer program product provide for post processing of images captured by an imaging system having multiple image capture devices to permit one or more of the images to be rotated relative to one or more other concurrently captured images. In the context of a method, a plurality of images are received of different portions of a scene captured concurrently by a plurality of image capture devices. The method includes rotating at least one of the images relative to at least one other image captured concurrently therewith. At least one of the images having relative rotation forms at least one rotated image. The method further includes stitching the at least one rotated image and the least one other image to form a panoramic image. The panoramic image includes at least one portion defined by at least one rotated image that is intentionally spatially incorrect.

### TECHNOLOGICAL FIELD

An example embodiment of the present disclosure relates generally to the generation of a panoramic image based upon images concurrently captured by a plurality of image capture devices and, more particularly, to the generation of a panoramic image having at least one portion that is spatially incorrect relative to the images captured by the plurality of image capture devices.

### BACKGROUND

In order to concurrently capture multiple images of a scene, multiple image capture devices may be configured to have at least partially different fields of view and may also be configured to concurrently capture the image within the respective fields of view. For example, the Ozo™ virtual reality camera by Nokia Technologies Oy includes eight image capture devices, such as eight video sensor arrays, having at least partially different fields of view and configured to concurrently capture images with a 360° surrounding scene. As a result of the different fields of view of each image capture devices, e.g., sensor, the individual images may be stitched together to create an immersive 360° panoramic image. The resulting immersive 360° panoramic images may be utilized for a variety of purposes including, for example, virtual reality applications.

In relation to an imaging system having multiple image capture devices, a director or other user responsible for the creation of the panoramic image may sometimes desire that the angle at which some, but not all of the images are captured be rotated relative to the angle at which the other images are captured. With respect to the Ozo imaging system, for example, a director may desire that the two typically horizontally orientated image capture devices facing forwardly continue to be orientated horizontally, but may desire that the two image capture devices facing rearward be rotated, such as upwardly or downwardly beyond the normal camera extrinsic for stitching, that is, beyond the hardware constraints imposed by the camera. In at least some imaging systems having multiple image capture devices, physical movement of the image capture devices relative to one another is limited due to, among other factors, the mechanical design of the imaging system, the weight of the imaging system and/or the stabilization requirements for the image capture devices. As a result of the construction and resulting mechanical limitations of the imaging systems, the director may be unable to concurrently capture images at a scene with one or more image capture devices rotated in the desired manner relative to the other image capture devices.

Further, a director or other user responsible for the generation of a panoramic image may have the imaging devices of such an imaging system configured as desired at the time of initially capturing the images. Sometime thereafter, however, the director or other user may determine that it would have instead been more desirable to have altered the angle at which one or more of the images were captured relative to other images that were concurrently captured. However, even if the imaging system were capable of capturing such differently rotated images, the director or other user may be unable to recreate the scene, such as due to changes in weather, unavailability of an actor or the like. As such, while imaging systems including multiple image capture devices create useful panoramic images, the resulting panoramic images are generally limited in terms of the relative rotation of the images with respect to one another due to the constraints imposed by the mechanical configuration of the imaging system.

### BRIEF SUMMARY

A method, apparatus and computer program product are provided in accordance with an example embodiment in order to provide for post processing of the images captured by an imaging system having multiple image capture devices. As such, the method, apparatus and computer program product of an example embodiment provide additional flexibility as result of the enhanced post processing such that a director or other user responsible for the generation of a panoramic image may modify the resulting panoramic image, thereby overcoming mechanical limitations of the imaging system and avoiding any need to recapture the images. For example, the method, apparatus and computer product of an example embodiment permit one or more of the images to be rotated relative to one or more other images that were concurrently captured by the image capture devices of the imaging system. By providing for relative rotation of a subset of the concurrently captured images and the stitching of the relatively rotated images, a panoramic image may be generated in accordance with an example embodiment that includes one or more portions that are intentionally spatially incorrect relative to the images captured concurrently captured by the image capture devices with the resulting spatial accuracy having been determined to be more desirable for any of a variety of reasons.

In an example embodiment, a method is provided that includes receiving a plurality of images of different portions of a scene captured concurrently by a plurality of image capture devices. The image capture devices are fixed in position relative to one another while concurrently capturing the plurality of images at the scene. The method also includes rotating at least one of the images relative to at least one other image captured concurrently therewith. At least one of the images having relative rotation forms at least one rotated image. The method of an example embodiment further includes stitching, such as by optical flow based stitching, the at least one rotated image and the least one other image to form a panoramic image of the scene. The panoramic image includes at least one portion defined by at least one rotated image that is spatially incorrect relative to plurality of images concurrently captured of the scene.

In an example embodiment, rotating at least one of the images includes determining a localized linear scale based upon a rotation matrix for each axis about which the at least one rotated image is rotated and a representation of a linear oblique seam. In this example embodiment, the rotation matrix is based upon an angle through which the at least one rotated image is rotated. The rotation matrix of an example embodiment is based upon an angle that is equal in magnitude but opposite in direction relative to the angle through which the at least one rotated image is rotated. In an example embodiment, rotating at least one of the images includes scaling coordinates of the at least one rotated image based upon the localized linear scale. Rotating at least one of the images may also include mapping two-dimensional coordinates of the rotated image to corresponding three-dimensional coordinates based upon the localized linear scale and the field of view of the rotated image.

In another example embodiment, an apparatus is provided that includes at least one processor and at least one memory including computer program code with the at least one memory, coupled to the at least one processor, and the computer program code configured to, when executed by a processor, cause the apparatus to receive a plurality of images of different portions of a scene captured concurrently by a plurality of image captures devices. The image capture devices are fixed in position relative to one another while concurrently capturing a plurality of images of the scene. The at least one memory and the computer program code are also configured to, when executed by the processor, cause the apparatus to rotate at least of the images relative to at least one other image captured concurrently therewith. The at least one of the images having relative rotation forms at least one rotated image. The at least one memory and the computer program code are also configured to, when executed by the processor, cause the apparatus to stitch, such as by optical flow based stitching, the at least one rotated image and the at least one other image to form a panoramic image of the scene. The panoramic image includes at least portion defined by the at least one rotated image that is spatially incorrect relative to the plurality of images concurrently captured of the scene.

The at least one memory and the computer code are configured to, when executed by the processor, cause the apparatus to rotate at least one of the images by determining a localized linear scale based upon a rotation matrix axis about which the at least one rotated image is rotated and a representation of a linear oblique seam. In this example embodiment, the rotation matrix is based upon an angle through the at least one rotated image is rotated. The rotation matrix may be based upon an angle that is equal in magnitude but opposite in direction relative to the angle through which the at one least rotated image is rotated. The at least one memory and the computer program code are configured to, when executed by the processor, cause the apparatus of an example embodiment to rotate at least one of the images by scaling coordinates of the at least one rotated image based upon the localized linear scale. The at least one memory and the computer program code are configured to, when executed by the processor, cause the apparatus to rotate at least one of the images by mapping two-dimensional coordinates of the rotated image to corresponding three-dimensional coordinates based upon the localized linear and a field of view of the rotated image.

In a further example embodiment, a computer program product includes a non-transitory computer readable storage medium comprising instructions that, when executed, are configured to cause receipt of a plurality of images of different portions of a scene captured concurrently by a plurality of image capture devices. The image capture devices are fixed in position relative to one another while concurrently capturing the plurality of images of the scene. The instructions, when executed, are also configured to cause rotation of at least one of the images relative to at least one other image captured concurrently therewith. The at least one of the images having relative rotation forms at least one rotated image. The instructions, when executed, are further configured to cause stitching of the at least one rotated image and the at least one other image to form a panoramic image of the scene. The panoramic image includes at least one portion defined by the at least one rotated image that is spatially incorrect relative to the plurality of images concurrently captured at the scene.

The instructions configured to cause rotating of at one of the images includes instructions configured to cause determination of a localized linear scale based upon a rotation matrix for each axis about which the at least one rotated image is rotated and a representation of a linear oblique seam. The rotation matrix of this example embodiment is based upon an angle through which the at least one rotated image is rotated. The rotation matrix may be based upon an angle that is equal in magnitude but opposite in direction relative to the angle through which the at least one rotated image is rotated. In an example embodiment, the instructions configured to cause rotating of at least one of the images include instructions configured to cause scaling of the coordinates of the at least one rotated image based upon the localized linear scale. In an example embodiment, the instructions configured to cause rotating of at least one of the images include instructions configured to cause mapping of two-dimensional coordinates of the rotated image, such as the final panoramic image, to corresponding three-dimensional coordinates, such as of its fisheye form, based upon the localized linear scale and a field of view of the rotated image.

In yet another example embodiment, an apparatus is provided that includes means for receiving a plurality of images of different portions of a scene captured concurrently by a plurality of image capture devices. The image capture devices are fixed in position relative to one another while concurrently capturing the plurality of images of the scene. The apparatus of this example embodiment also includes means for rotating at least one of the images relative to at least one other image captured concurrently therewith. The at least one of the images having relative rotation fauns at least one rotated image. The apparatus of this embodiment further includes means for stitching the at least one rotated image and the at least one other image to form a panoramic image of the scene. The panoramic image includes at least a portion defined by the at least one rotated image that is spatially incorrect relative to the plurality of images concurrently captured of the scene.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1 is a perspective view of an imaging system including a plurality of image capture devices having at least partially different fields of view;

FIG. 2 is a block diagram of an apparatus that may be specifically configured in accordance with an example embodiment of the present disclosure;

FIG. 3 is a flowchart illustrating operations performed, such as by the apparatus of FIG. 2, in accordance with an example embodiment of the present disclosure;

FIG. 4 is an illustration of an image captured by one image capture device of an imaging system having multiple image capture devices;

FIG. 5 is an illustration of the image of FIG. 4 following rotation of the image about the x axis; and

FIG. 6 is a flowchart illustrating operations performed, such as by the apparatus of FIG. 2, in order to rotate at least one of the images in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, field programmable gate array, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

A method, apparatus and computer program product are provided in accordance with an example embodiment in order generate a panoramic image, such as an immersive 360° panoramic image, in which a plurality of images captured concurrently by multiple image capture devices of an imaging system are stitched together following post processing in which one or more of the images are rotated relative to one or more other images prior to being stitched together to form the panoramic image. Although the resulting panoramic image includes at least one portion formed by the rotated image(s) that is spatially incorrect relative to the plurality of images that were concurrently captured by the image capture devices, the post processing rotation provided in accordance with an example embodiment permits the resulting panoramic image to be modified without having to mechanically alter the imaging system and without having to repeat the image capture process. Thus, the method, apparatus and computer program product of an example embodiment enhance the flexibility associated with such imaging systems.

The resulting panoramic image is comprised of a plurality of images concurrently captured by a plurality of image capture devices. As used herein, the images may include both still images, a series of still images, a video comprised of a plurality of individual images or the like. Regardless of the type of image, the images are concurrently captured by a plurality of image capture devices. The image capture devices may include cameras, image sensor arrays or other types of devices or sensors configured to record images, either within the visible wavelengths or in other frequency bands. As such, any reference herein to a camera is used by way of example of any of a wide array of image capture devices. The plurality of image capture devices configured to concurrently capture the images may part of an imaging system. One example of such an imaging system is the Ozo™ virtual reality camera by Nokia Technologies Oy. However, other types of imaging systems including a plurality of image capture devices configured to concurrently capture a plurality of images of a scene may also benefit from example embodiments of the present disclosure.

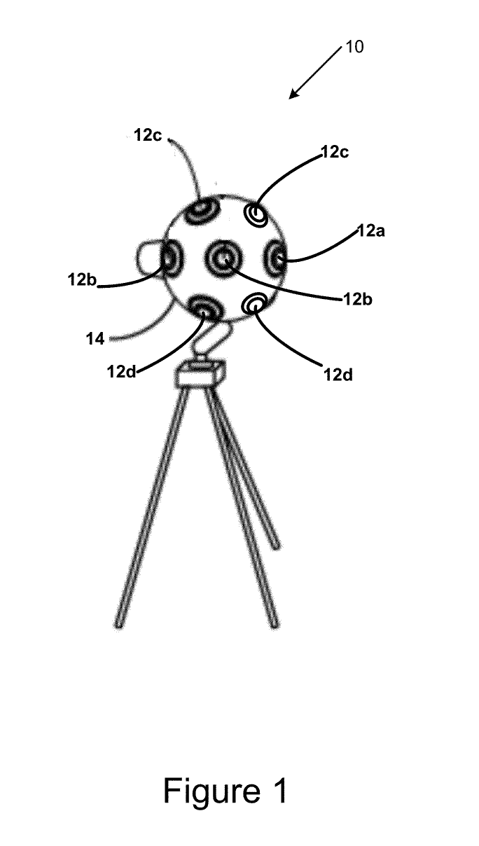

With respect to an imaging system that includes a plurality of image capture devices having different fields of view and configured to concurrently capture images of a scene, the imaging system may be configured such that the different image capture devices have at least partially different fields of view. As such, the images that are concurrently captured may be stitched together in order to generate a panoramic image, such as an immersive 360° panoramic image, as used, for example, for virtual reality and other applications. One example of an imaging system 10 that includes a plurality of image capture devices 12 is depicted in FIG. 1. As shown, the imaging system includes eight image capture devices disposed within a housing 14 and having at least partially different fields of view. In this configuration, two of the image capture devices 12a generally face horizontally and forwardly, while two other image capture devices 12b generally face horizontally and rearwardly. Further, two additional image capture devices 12c generally face vertically upward, and two other image capture devices 12d generally face vertically downward.

Although it is sometimes desirable to alter, e.g., rotate, the angle at which an image is captured by one of the image capture devices relative to other image capture devices, imaging systems 10 that include a plurality of image capture devices 12 are not generally flexible in terms of providing for relative rotation between the image capture devices due, at least in part, to the mechanical configuration of the image capture devices within the housing 14 and issues relating to stabilization of the image capture devices. Further, the view angle of the image capture devices of an imaging system may not be readily altered. Consequently, imaging systems including multiple image capture devices may reliably capture and generate panoramic images, but such imaging systems do not conventionally permit certain images captured by a subset of the image capture devices to be altered, such in terms of rotation or view angle, relative to the images concurrently captured by the other image capture devices.

In some instances, however, it is desirable that the images captured by one or more of the image capture devices be rotated relative to the images concurrently captured by the other image capture devices of an imaging system. For example, after having captured the plurality of images with the image capture devices of such an imaging system, a director or other user responsible for the generation of the panoramic image may desire to alter the image(s) captured by one or more of the image capture devices, such as in terms of the rotation of the image(s), relative to the images captured by the other image capture devices, such as to by rotating the image(s) downwardly or upwardly to simulate the view of an audience that is located above or below the stage, respectively. However, not only are such imaging systems difficult to modify in order to alter the relative rotation between the images captured by the different image capture devices, but the original scene may be unable to be recreated due to weather conditions, the availability of actors, the impromptu nature of the original scene or the like. In accordance with an example embodiment, however, the apparatus, method and computer program product of an example embodiment permit one or more of the images captured by image capture devices to be rotated relative to the images concurrently captured by the other image capture devices prior to stitching the images together to generate the panoramic image. Although the resulting panoramic image is spatially incorrect relative to the plurality of images concurrently captured by the image capture devices of the scene as a result of the rotation of one or more of the images, the resulting panoramic image may better align with the desires of the director or other user responsible for generation of the panoramic image.

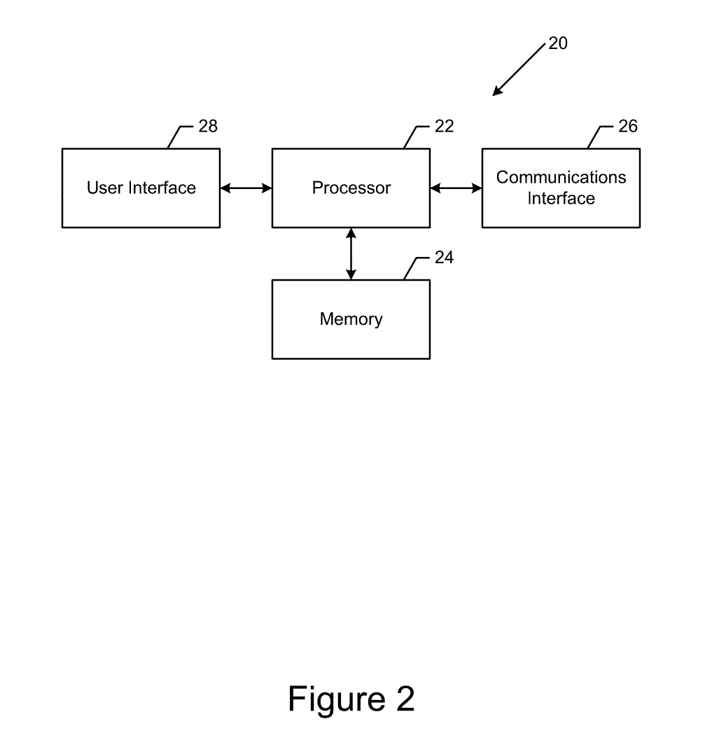

The apparatus configured to generate a panoramic image in accordance with an example embodiment may be embodied by a variety of different computing devices, such as a computer workstation, a personal computer, an image processing system, a server, a distributed computing network or the like. Regardless of the manner in which the apparatus is embodied, the apparatus 20 of an example embodiment may be configured as shown in FIG. 2 so as to include, be associated with or otherwise be in communication with a processor 22 and a memory 24 and optionally with a communication interface 26 and/or a user interface 28.

In some embodiments, the processor 22 (and/or co-processors or any other processing circuitry assisting or otherwise associated with the processor) may be in communication with the memory device 24 via a bus for passing information among components of the apparatus 20. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor 20. Additionally or alternatively, the memory device could be configured to store instructions for execution by the processor.

The apparatus 20 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., an image processing system) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In embodiments that include an optional communication interface 26, the communication interface may be any means such as a device or circuitry embodied in either hardware or a combination of hardware and software that is configured to receive and/or transmit data from/to a network and/or any other device or module in communication with the apparatus 20. In this regard, the communication interface may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface may include a communication modem and/or other hardware/software for supporting communication via cable, digital subscriber line (DSL), universal serial bus (USB) or other mechanisms.

In some embodiments, such as instances in which the apparatus 20 is embodied by a user device, the apparatus may optionally include a user interface 28 that may, in turn, be in communication with the processor 22 to receive an indication of a user input, such as user input defining the particular images to be rotated and the extent of the rotation, and/or to cause provision of an audible, visual, mechanical or other output to the user, such as the display of the resulting panoramic image. As such, the user interface may include, for example, a keyboard, a mouse, a joystick, a display, a touch screen(s), touch areas, soft keys, a microphone, a speaker, or other input/output mechanisms. For example, the user interface of some embodiments may be a virtual reality display, such as a virtual reality headset, goggles or other head mounted display. Alternatively or additionally, the processor may comprise user interface circuitry configured to control at least some functions of one or more user interface elements such as, for example, a speaker, ringer, microphone, display, and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

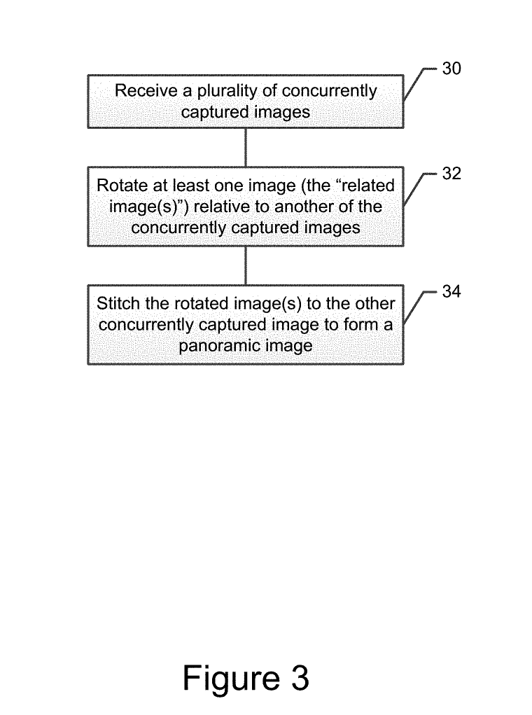

The operations performed, such as by the apparatus 20 of FIG. 2, in accordance with an example embodiment will now be described by way of example, but not of limitation, with respect to the flowchart of FIG. 3. In order to generate a panoramic image that includes at least one portion that has been rotated during post processing relative to other images that were concurrently captured by the image capture devices 12 of an imaging system 10, the apparatus of an example embodiment includes means, such as the processor 22, the communication interface 26 or the like, for receiving a plurality of images of different portions of a scene captured concurrently by a plurality of image capture devices. See block 30 of FIG. 3. In this regard, the apparatus may be configured to receive, such as via the communication interface, the images of different portions of the scene concurrently captured by the plurality of image capture devices. The images may be received directly from the imaging system or the images captured by the plurality of image capture devices of such an imaging system may be stored, such as in a database, and then subsequently retrieved, such as by the processor via the communication interface for post processing. Although the imaging system including the plurality of image capture devices may be remote from the apparatus in some embodiments, the apparatus of an example embodiment may also include the imaging system including the plurality of image capture devices such that the images captured by the image capture devices may be provided directly to the processor for post processing as described herein. Regardless of the relationship of the imaging system to the apparatus, the image capture devices are fixed in position relative to one another while concurrently capturing a plurality of images of the scene and, in some embodiments, are permanently fixed in position relative to one another as a result of the mechanical construction of the imaging system. While the plurality of images concurrently captured by the image capture devices may collectively encompass the entire 360° field of view of the scene, the images may include a more limited range in other embodiments.

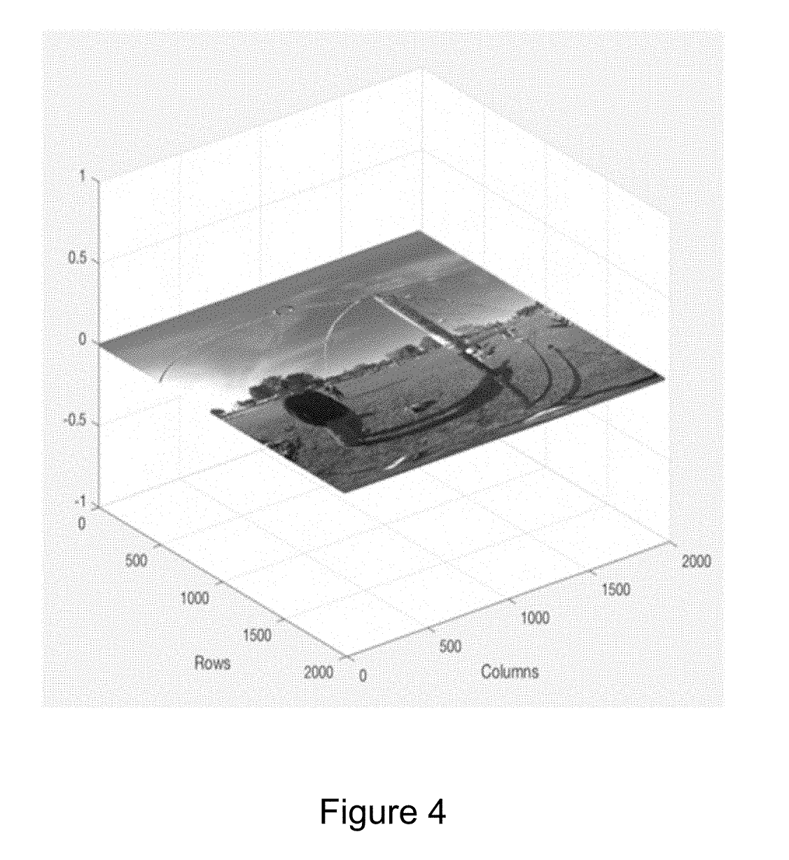

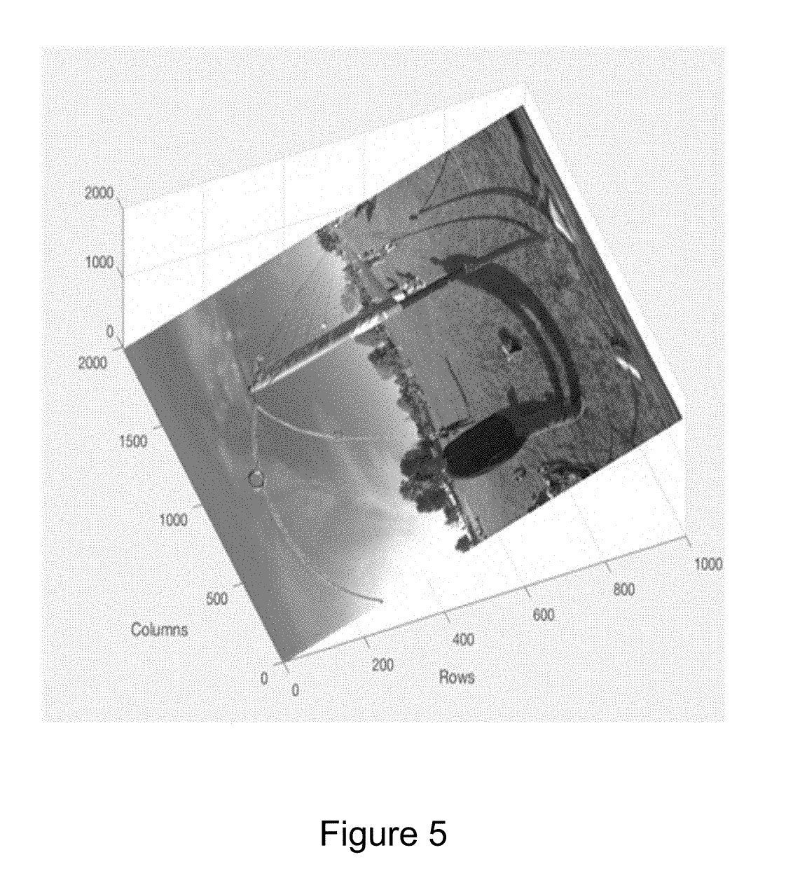

As shown in block 32 of FIG. 3, the apparatus 20 also includes means, such as the processor 22 or the like, for rotating at least one of the images (during post processing following capture of the images) relative to at least one other image captured concurrently therewith. The image(s) having relative rotation may be referenced as rotated image(s) hereinafter. The number of rotated images, the particular images that are rotated relative to the other images and the extent of the rotation, such as in terms of degrees of rotation, may be predefined or may be defined by a user, such as based upon input provided via the user interface 28, depending upon the affect that is desired in the resulting panoramic image. Each rotated image is generally rotated about one or more axes, such as the x, y and z axes. By way of example, FIG. 4 depicts an image captured by a respective image capture device prior to the application of any rotation thereto. As shown in FIG. 5, the image may be rotated about the x axis by a predetermined amount, such as a predetermined angular amount. Although FIG. 5 depicts the rotation about a single axis, that is, the x axis, the image may be rotated about two or three axes in other embodiments with the extent of the rotation about each axis being either the same or different as may be defined, for example, in a predefined manner or by a user.

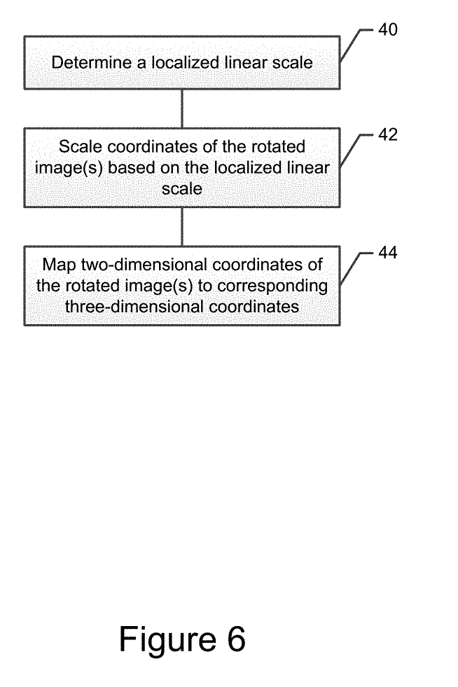

Further details regarding the rotation of at least one of the images as shown generally by block 32 of FIG. 3 in accordance with an example embodiment are now described in relation to FIG. 6. In this regard, in order to rotate at least one of the images, the apparatus 20 includes means, such as the processor 22 or the like, for determining a localized linear scale. See block 40 of FIG. 6. In this regard, the localized linear scale may be based upon a rotation matrix for each axis about which the at least one rotated image is rotated as well as a representation of a linear oblique seam. While the localized linear scale may be defined in various manners, the localized linear scale of one example embodiment may be defined as:

scale(x, y)=f(Rx(−θ)*Ry(−φ)*Rz(−υ))(x, y)*obseam(x, y)*o(x, y)

In this example embodiment, a representation of the linear oblique seam obseam (x, y) may be defined as:

$$obseam ( x , y ) = a + \frac{1.0 - a}{‖ obpos ( x , y ) - normpos ( x , y ) ‖} ‖ ( ( x , y ) - normpos ( x , y ) ‖$$

wherein 0«a<1.0. In the foregoing equation, normpos(x, y) can provide values from the panoramic image at various seam positions defined by the (x, y) coordinates, such as at the 90° seam position. In this regard, the panoramic image width is in pixels, but can alternatively be expressed in degrees from −180° to 180°. The 90° seam position is therefore at the ¾^{th} width position, such that normpos(x, y) provides (x, y) values with x fixed at the 90° position and y varying from the top of the image to the bottom of the image. So, at the 90° seam position, for a panoramic image having a width and height of panoramaWidth and panoramaHeight, respectively:

$$normpos ( x , y ) = ( \frac{90 - ( - 180 )}{360} ⋆ panoramaWidth , y ) = ( 0.75 ⋆ panoramaWidth , y ) , 0 \leq y < panoramaHeight .$$

In addition, obpos(x, y) can define values from the panoramic image along an oblique line, such as a line extending through the center of the 90° seam position, that is, with (x0, y0)=(0.75*panoramaWidth, 0.5*panoramaHeight), but with a predefined slope, such as a slope of tan(75°)=3.732, such that obpos(x, y) of this example can be defined as:

$$obpos ( x , y ) = ( \frac{y - 0.5 ⋆ panoramaHeight}{3.732} + 0.75 ⋆ panoramaWidth , y ) , 0 \leq y < panoramaHeight .$$

While particular angles are provided above by way of example, normpos(x, y) and obpos(x, y) may be evaluated at different angular positions in other embodiments. Additionally, Rₓ, R_{y} and R_{z} are rotation matrices about the x, y and z axes, respectively, and the function f(Rx(−θ)*Ry(−φ)*Rz(−υ))(x, y) may be any of various functions to obtain (x, y) coordinates from (x, y, z) coordinates. As such, scale(x, y) is a two dimensional coordinate mapping function. While the rotation matrices may be defined in various manners, the rotation matrices of one example embodiment are as follows:

$${R}_{x} ( θ ) = [ \begin{matrix}1 & 0 & 0 \\ 0 & cos θ & - sin θ \\ 0 & sin θ & cos θ\end{matrix} ]$$

$${R}_{y} ( θ ) = [ \begin{matrix}cos θ & 0 & sin θ \\ 0 & 1 & 0 \\ - sin θ & 0 & cos θ\end{matrix} ]$$

$${R}_{z} ( θ ) = [ \begin{matrix}cos θ & - sin θ & 0 \\ sin θ & cos θ & 0 \\ 0 & 0 & 1\end{matrix} ]$$

In the foregoing example, each of the rotation matrices are defined for the same rotation angle (θ) about the x, y and z axes. However, the image may be rotated by different rotation angles, such as by θ, φ and υ about the x, y and z axes, respectively, in other embodiments, such as that described above with respect to the determination of the localized linear scale. In this regard and with respect to the determination of the localized linear scale, the rotation matrices are evaluated at angles that are equal in magnitude but opposite in direction or sign relative to the angle about which the image is rotated relative to the x, y and z axes. In this regard, the image may be rotated about the x, y and z axes by θ, φ and υ, respectively, such that the rotation matrices are evaluated in conjunction with the localized linear scale as shown above at −θ, −φ and −υ with respect to the Rₓ, R_{y} and R_{z} rotation matrices, respectively.

The angle about which an image is rotated may be spatially incorrect relative to the field of view of image capture device in relation to the neighboring image capture devices, but it provides for a creative choice that may be selected based upon a director's preference. For example, in a ring of 6 cameras spanning a 360° circle horizontally, two neighboring cameras (such as labelled as cameraL on the left and cameraR on the right) have a separation of 60°. In a normal stitching scheme, cameraL may rotate to the right by 30° and cameraR may also rotate to the left by 30° to see the scene in the same planar way. However, a director's creative view might require rotation of the two cameras so as to only be separated by 50°, which may be brought about by post processing with the resulting panoramic image still being stitched seamlessly and continuously.

The rotated image may also be modified in other manners in order to further manipulate the content represented by the image. As such, the foregoing equation representative of an example of the localized linear scale includes a term o(x, y) representative of other forms of content manipulation. However, in some embodiments, no additional content manipulation is to be provided such that the term o(x, y) reduces to 1.

As an alternative to the foregoing determination of the localized linear scale that takes into account the rotation of the image about the respective axes and the linear oblique seam, the apparatus 20 of an example embodiment, such the processor 22 or the like, may alternatively be configured to determine the scale by generating a numerical scale map. In this regard, the numerical scale map may define a lookup table that provides a numerical approximation of the localized linear scale at each of the plurality of points (x, y) in the final panoramic image. One example is that the numerical scale map may be defined as a scale map transferred from a segmented edge map from a natural scene for seamlessly warp the neighboring two cameras according to prominent edges, which might be computationally extensive if calculated mathematically.

In accordance with an example embodiment, the apparatus 20 includes means, such as the processor 22 or the like, for scaling coordinates of the at least one rotated image based upon the localized linear scale. See block 42 of FIG. 6. Although the coordinates may be scaled in various manners, the apparatus, such as the processor, of an example embodiment is configured to scale the coordinate in such a manner as to generate scaled coordinates (x′, y′) as follows:

(x′, y′)=(x*scale(x, y), y*(scale(x, y))

wherein (x, y) are the original coordinates within the image captured by a respective image capture device 12. Although the coordinates themselves are scaled to account for the rotation, the pixel value at the respective coordinate location generally remains the same as that captured by the respect image capture device.

In the foregoing example, the rotation matrices are utilized in conjunction with the definition of the localized linear scale. However, the rotation matrices may, alternatively, be utilized, not in conjunction with the determination of the localized linear scale, but, instead, in conjunction with the scaling of the coordinates of the at least one rotated image. In this example embodiment, the coordinates (x, y) would be multiplied not only by the localized linear scale (based upon the representation of the linear oblique seam obseam (x, y) and o(x, y) representative of other forms of content manipulation but not the rotation matrices) and the value of the coordinates, but also by the rotation matrices, such as defined above, with respect to rotation of about the x, y and x axes by θ, φ and υ, respectively. In contrast to the manner in which the rotation matrices are applied during the determination of the localized linear scale, the application of the rotation matrix during the scaling of the coordinates of the rotated image utilizes the actual angles by which the image is to be rotated about the respective axes, namely, θ, φ and υ, respectively.

In order to facilitate the generation of a 360° or other spherical or semispherical panoramic image and to allow for stitching of the images concurrently captured by the plurality of image capture devices 12 including those images that have been rotated, the apparatus 20 of an example embodiment also includes means, such as the processor 22 or the like, for mapping the two dimensional coordinates of the rotated image, such as those scaled as described above in conjunction with the scaled coordinates (x′, y′), to corresponding three dimensional coordinates. See block 44 of FIG. 6. The mapping of the two dimensional coordinates to the corresponding three dimensional fisheye coordinates may be based upon the localized linear scale and a field of view Ω of the rotated image. In an example embodiment, the three dimensional coordinates (X, Y, Z) may be determined from the two dimensional coordinates, e.g., the scaled coordinates (x′, y′) defined as (x*scale(x, y), y*(scale(x, y)), as follows:

$$( X , Y , Z ) = ( \frac{x ⋆ ( scale ( x , y ) )}{γ} ⋆ sin φ , \frac{y ⋆ ( scale ( x , y ) )}{γ} ⋆ sin φ , cos φ )$$

In this regard, γ is defined as:

γ={square root over ((x*scale(x, y))²+(y*scale(x, y))²)}

Additionally, in instances in which the field of view (FOV) of the respective image is Ω, ϕ is defined as: φ=γ*Ω. Thus, the spherical (x, y) coordinates are effectively mapped as described above into corresponding three-dimensional fisheye coordinates to facilitate stitching of the images and the rendering of a coherent panoramic image having one or more rotated images defining portions thereof.

Following rotation of at least one image and as shown in block 34 of FIG. 3, the apparatus 20 also includes means, such as the processor 22 or the like, for stitching the at least one rotated image and at least other image to form a panoramic image of the scene. In this regard, the apparatus, such as the processor, is configured to stitch a representation of each image concurrently captured by the plurality of image capture devices 12 to form a panoramic image, such as an immersive 360° panoramic image. In relation to the representation of the images that are stitched, the rotated image for each of the images that have been rotated are stitched along with each image that has not been rotated. The apparatus, such as the processor, may be configured to utilize a variety of different forms of stitching including, for example, optical flow based stitching.

The resulting panoramic image includes at least one portion defined by at least one rotated image that is spatially incorrect relative to the plurality of images concurrently captured of the scene. In this regard, the portion of the panoramic image formed by the at least one rotated image has been rotated through post processing relative to the image that was actually captured by the corresponding image capture device such that the resulting panoramic image is spatially incorrect, as a result of the post processing rotation relative to the image as captured. However, the stitched panoramic image of an example embodiment is still continuous and seamless with a portion of the image modified beyond its normal camera extrinsic, that is, beyond the hardware constraints associated with the respective image capture device, so as to be spatially incorrect relative to the images captured by the neighboring image capture devices. The resulting panoramic image may then be stored, such as in memory 24, or output to a user, such as via the user interface 28. For example, in an example embodiment in which the user interface is a virtual reality display, such as a virtual reality headset or goggles, the apparatus 20, such as the processor 22, may cause the panoramic image to be rendered via the virtual reality display such that the user is immersed in the scene as captured by the image capture devices, albeit with at least a portion of the panoramic image having been rotated relative to the image that was actually captured.

The relative rotation of one or more images with respect to other images concurrently captured by the plurality of image capture devices 12 may be utilized for various purposes. For example, a director or other user responsible for the generation of a panoramic image may alter a portion of the panoramic image through the generation and display of a rotated image, such as to view the scene from a different angle (such as by looking up or down or viewing the scene from a different vantage point) without having to attempt to capture the scene again following modification of the imaging system 10 including the plurality of image capture devices, even if the modification of the image capture devices were possible. In this regard, in an instance in which ab imaging system having a plurality of image capture devices does permit relative rotation of at least some of the image capture devices, the method, apparatus 20 and computer program product of an example embodiment permit a panoramic image including a portion that has been rotated through post processing to be generated in order to allow a director or other user to evaluate the appearance of the resulting panoramic image if one or more of the image capture devices were actually rotated relative to other image capture devices of the imaging system prior to physically modifying the imaging system. Thus, any mechanical modification of the imaging system may be previewed in advance and therefore more accurately performed.

As described above, FIGS. 3 and 6 illustrates flowcharts of an apparatus 20, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a plurality of images of different portions of a scene captured concurrently by a plurality of image capture devices, wherein the image capture devices are fixed in position relative to one another while concurrently capturing the plurality of images of the scene;
rotating at least one of the images relative to at least one other image captured concurrently therewith, wherein the at least one of the images having relative rotation forms at least one rotated image; and
stitching the at least one rotated image and the at least one other image to form a panoramic image of the scene, wherein the panoramic image includes at least one portion defined by the at least one rotated image that is spatially incorrect relative to the plurality of images concurrently captured of the scene.

2. A method according to claim 1 wherein rotating at least one of the images comprises determining a localized linear scale based upon a rotation matrix for each axis about which the at least one rotated image is rotated and a representation of a linear oblique seam.

3. A method according to claim 2 wherein the rotation matrix is based upon an angle through which the at least one rotated image is rotated.

4. A method according to claim 3 wherein the rotation matrix is based upon an angle that is equal in magnitude but opposite in direction relative to the angle through which the at least one rotated image is rotated.

5. A method according to claim 2 wherein rotating at least one of the images comprises scaling coordinates of the at least one rotated image based upon the localized linear scale.

6. A method according to claim 2 wherein rotating at least one of the images comprises mapping two dimensional coordinates of the rotated image to corresponding three dimensional coordinates based upon the localized linear scale and a field of view of the rotated image.

7. A method according to claim 1 wherein stitching the at least one rotated image and the at least one other image utilizes optical flow based stitching.

8. An apparatus comprising at least one processor and at least one memory including computer program code, the at least one memory coupled to the at least one processor, and the computer program code configured to, when executed by a processor, cause the apparatus to:
receive a plurality of images of different portions of a scene captured concurrently by a plurality of image capture devices, wherein the image capture devices are fixed in position relative to one another while concurrently capturing the plurality of images of the scene;
rotate at least one of the images relative to at least one other image captured concurrently therewith, wherein the at least one of the images having relative rotation forms at least one rotated image; and
stitch the at least one rotated image and the at least one other image to form a panoramic image of the scene, wherein the panoramic image includes at least one portion defined by the at least one rotated image that is spatially incorrect relative to the plurality of images concurrently captured of the scene.

9. An apparatus according to claim 8 wherein the at least one memory and the computer program code are configured to, when executed by the processor, cause the apparatus to rotate at least one of the images by determining a localized linear scale based upon a rotation matrix for each axis about which the at least one rotated image is rotated and a representation of a linear oblique seam.

10. An apparatus according to claim 9 wherein the rotation matrix is based upon an angle through which the at least one rotated image is rotated.

11. An apparatus according to claim 10 wherein the rotation matrix is based upon an angle that is equal in magnitude but opposite in direction relative to the angle through which the at least one rotated image is rotated.

12. An apparatus according to claim 9 wherein the at least one memory and the computer program code are configured to, when executed by the processor, cause the apparatus to rotate at least one of the images by scaling coordinates of the at least one rotated image based upon the localized linear scale.

13. An apparatus according to claim 9 wherein the at least one memory and the computer program code are configured to, when executed by the processor, cause the apparatus to rotate at least one of the images by mapping two dimensional coordinates of the rotated image to corresponding three dimensional coordinates based upon the localized linear scale and a field of view of the rotated image.

14. An apparatus according to claim 8 wherein the at least one memory and the computer program code are configured to, when executed by the processor, cause the apparatus to stitch the at least one rotated image and the at least one other image utilizing optical flow based stitching.

15. A computer program product comprising a non-transitory computer readable storage medium, the non-transitory computer readable storage medium comprising instructions that, when executed, are configured to cause:
receiving a plurality of images of different portions of a scene captured concurrently by a plurality of image capture devices, wherein the image capture devices are fixed in position relative to one another while concurrently capturing the plurality of images of the scene;
rotating at least one of the images relative to at least one other image captured concurrently therewith, wherein the at least one of the images having relative rotation forms at least one rotated image; and
stitching the at least one rotated image and the at least one other image to form a panoramic image of the scene, wherein the panoramic image includes at least one portion defined by the at least one rotated image that is spatially incorrect relative to the plurality of images concurrently captured of the scene.

16. A computer program product according to claim 15 wherein the instructions configured to cause rotating of at least one of the images comprise instructions configured to cause determining a localized linear scale based upon a rotation matrix for each axis about which the at least one rotated image is rotated and a representation of a linear oblique seam.

17. A computer program product according to claim 16 wherein the rotation matrix is based upon an angle through which the at least one rotated image is rotated.

18. A computer program product according to claim 17 wherein the rotation matrix is based upon an angle that is equal in magnitude but opposite in direction relative to the angle through which the at least one rotated image is rotated.

19. A computer program product according to claim 16 wherein the instructions configured to cause rotating of at least one of the images comprise instructions configured to cause scaling of coordinates of the at least one rotated image based upon the localized linear scale.

20. A computer program product according to claim 16 wherein the instructions configured to cause rotating of at least one of the images comprise instructions configured to cause mapping of two dimensional coordinates of the rotated image to corresponding three dimensional coordinates based upon the localized linear scale and a field of view of the rotated image.
